(19) United States
(12) Patent Application Publication
(10) Pub. No.: US 2023/0137432 A1
(43) Pub. Date: May 4, 2023

(54) HYBRID MACHINE LEARNING TECHNIQUES USING CO-OCCURRENCE-BASED REPRESENTATIONS AND TEMPORAL REPRESENTATIONS

(71) Applicant: Optum Services (Ireland) Limited, Dublin (IE)

(72) Inventors: Ahmed Selim, Dublin (IE); Michael J. McCarthy, Dublin (IE); Mostafa Bayomi, Dublin (IE); Kieran O'Donoghue, Dublin (IE); Michael Bridges, Dublin (IE)

(21) Appl. No.: 17/453,061

(22) Filed: Nov. 1, 2021

(51) Int. Cl. G06N 5/04

(52) U.S. Cl. CPC G06N 5/04

(57) ABSTRACT

Various embodiments of the present invention provide methods, apparatus, systems, computing devices, computing entities, and/or the like for performing predictive data analysis with respect to input data entities that describe temporal relationships across a large number of prediction input codes. Certain embodiments of the present invention utilize systems, methods, and computer program products that perform predictive data analysis by using hybrid prediction scores that are determined based at least in part on co-occurrence-based prediction scores and temporal prediction scores, where the co-occurrence-based prediction scores are determined based at least in part on co-occurrence-based historical representation of a sequence of prediction input codes and temporal historical representation of the sequence of prediction input codes.

### BACKGROUND

Various embodiments of the present invention address technical challenges related to performing predictive data analysis with respect to input data entities that describe temporal relationships across a large number of prediction input codes. Various embodiments of the present invention address the shortcomings of existing machine learning systems and disclose various techniques for efficiently and reliably performing predictive data analysis with respect to input data entities that describe temporal relationships across a large number of prediction input codes.

### BRIEF SUMMARY

In general, embodiments of the present invention provide methods, apparatus, systems, computing devices, computing entities, and/or the like for performing predictive data analysis with respect to input data entities that describe temporal relationships across a large number of prediction input codes. Certain embodiments of the present invention utilize systems, methods, and computer program products that perform predictive data analysis by using hybrid prediction scores that are determined based at least in part on co-occurrence-based prediction scores and temporal prediction scores, where the co-occurrence-based prediction scores are determined based at least in part on co-occurrence-based historical representation of a sequence of prediction input codes and temporal historical representation of the sequence of prediction input codes.

In accordance with one aspect, a method is provided. In one embodiment, the method comprises: identifying a co-occurrence-based historical representation of a sequence of prediction input codes, wherein: (i) each prediction input code is associated with an event data object of a sequence of event data objects, (ii) the co-occurrence-based historical representation is determined based at least in part on each event representation for the sequence of event data objects, and (iii) each event representation is determined based at least in part on each code representation for a code subset of the sequence of prediction input codes that is associated with the event data object for the event representation; identifying a temporal representation of the sequence of prediction input codes, wherein: (i) each prediction input code is associated with a timestamp, and (ii) the temporal representation is determined based at least in part on each timestamp; determining, using a co-occurrence-based prediction machine learning model and based at least in part on the co-occurrence-based historical representation, a co-occurrence-based prediction score for a predictive entity; determining, using a temporal prediction machine learning model and based at least in part on the temporal representation, a temporal prediction score for the predictive entity; determining, based at least in part on the co-occurrence-based prediction score and the temporal prediction score, the hybrid prediction score; and performing one or more prediction-based actions based at least in part on the hybrid prediction score.

In accordance with another aspect, a computer program product is provided. The computer program product may comprise at least one computer-readable storage medium having computer-readable program code portions stored therein, the computer-readable program code portions comprising executable portions configured to: identify a co-occurrence-based historical representation of a sequence of prediction input codes, wherein: (i) each prediction input code is associated with an event data object of a sequence of event data objects, (ii) the co-occurrence-based historical representation is determined based at least in part on each event representation for the sequence of event data objects, and (iii) each event representation is determined based at least in part on each code representation for a code subset of the sequence of prediction input codes that is associated with the event data object for the event representation; identify a temporal representation of the sequence of prediction input codes, wherein: (i) each prediction input code is associated with a timestamp, and (ii) the temporal representation is determined based at least in part on each timestamp; determine, using a co-occurrence-based prediction machine learning model and based at least in part on the co-occurrence-based historical representation, a co-occurrence-based prediction score for a predictive entity; determine, using a temporal prediction machine learning model and based at least in part on the temporal representation, a temporal prediction score for the predictive entity; determine, based at least in part on the co-occurrence-based prediction score and the temporal prediction score, the hybrid prediction score; and perform one or more prediction-based actions based at least in part on the hybrid prediction score.

In accordance with yet another aspect, an apparatus comprising at least one processor and at least one memory including computer program code is provided. In one embodiment, the at least one memory and the computer program code may be configured to, with the processor, cause the apparatus to: identify a co-occurrence-based historical representation of a sequence of prediction input codes, wherein: (i) each prediction input code is associated with an event data object of a sequence of event data objects, (ii) the co-occurrence-based historical representation is determined based at least in part on each event representation for the sequence of event data objects, and (iii) each event representation is determined based at least in part on each code representation for a code subset of the sequence of prediction input codes that is associated with the event data object for the event representation; identify a temporal representation of the sequence of prediction input codes, wherein: (i) each prediction input code is associated with a timestamp, and (ii) the temporal representation is determined based at least in part on each timestamp; determine, using a co-occurrence-based prediction machine learning model and based at least in part on the co-occurrence-based historical representation, a co-occurrence-based prediction score for a predictive entity; determine, using a temporal prediction machine learning model and based at least in part on the temporal representation, a temporal prediction score for the predictive entity; determine, based at least in part on the co-occurrence-based prediction score and the temporal prediction score, the hybrid prediction score; and perform one or more prediction-based actions based at least in part on the hybrid prediction score.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a flowchart diagram of an example process for generating a hybrid prediction score based at least in part on a co-occurrence-based prediction score and a temporal prediction score in accordance with some embodiments discussed herein.

FIG. 5 is a flowchart diagram of an example process for generating a co-occurrence-based historical representation of a sequence of prediction input codes in accordance with some embodiments discussed herein.

FIG. 6 provides an operational example of image channel representations for a prediction input code in accordance with some embodiments discussed herein.

FIG. 7A and FIG. 7B provide an operational example of resizing operations performed image channel representations for a prediction input code in accordance with some embodiments discussed herein.

FIG. 8 provides an operational example of integrating image channel representations for a prediction input code into other resized image channel representations for the prediction input code in accordance with some embodiments discussed herein.

FIG. 9 provides an operational example of image representations for two prediction input codes in accordance with some embodiments discussed herein.

FIG. 10 provides an operational example of generating expanded event representations for three image channel representations in accordance with some embodiments discussed herein.

FIG. 11 provides an operational example of generating a compact event representation for an event data object in accordance with some embodiments discussed herein.

FIG. 12 provides an operational example of a co-occurrence-based historical representation including per-channel representation segments for image channel representations in accordance with some embodiments discussed herein.

FIG. 13 provides an operational example of a co-occurrence-based historical representation including cumulative per-channel representation segments for image channel representations in accordance with some embodiments discussed herein.

FIG. 14 provides an operational example of a co-occurrence-based historical representation including cumulative expanded representations for image channel representations in accordance with some embodiments discussed herein.

FIG. 15 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW AND TECHNICAL ADVANTAGES

Various embodiments of the present invention address operational efficiency and operational reliability of predictive data analysis systems that are configured to perform predictive data analysis operations with respect to input data entities that describe temporal relationships across a large number of prediction input codes. For example, various embodiments of the present invention improve accuracy of predictive outputs generated based at least in part on input data entities that describe temporal relationships across a large number of prediction input codes by using hybrid prediction scores that are determined based at least in part on co-occurrence-based prediction scores and temporal prediction scores, where the co-occurrence-based prediction scores are determined based at least in part on co-occurrence-based historical representation of a sequence of prediction input codes and temporal historical representation of the sequence of prediction input codes. Improving accuracy of predictive output in turn: (i) decreases the number of computational operations performed by processing units of predictive data analysis systems, thus increasing the computational efficiency of predictive data analysis systems, (ii) decreases the overall likelihood of system failure given a constant per-recommendation likelihood failure, thus increasing operational reliability of predictive data analysis systems, and (iii) increases the overall number of end-users that the predictive data analysis system can serve given a constant per-user query count, thus increasing the operational throughput of predictive data analysis systems. Accordingly, various embodiments of the present disclosure make important technical contributions to the field of predictive data analysis by improving computational efficiency, operational reliability, and operational throughput of predictive data analysis systems.

An exemplary application of various embodiments of the present invention relates to enabling a framework for building disease progression models. These models utilize the medical history of a patient to predict the likelihood of developing specific conditions/diseases in the future. The current approach to the noted problem on using temporal information, and on building machine learning (ML) models that ingests this type of data. While this approach has good performance in general, there are issues with real-world medical health records that prevent these models to achieve better performance. More specifically, medical health records for a member come in a series of events. Each event represents a doctor visit, a medical operation, a prescription, and/or the like. Codes from multiple standards are used to define each of these events. ML models used to generate disease risk predictions by using these events, the order by which these events occurred, as well as the time difference between these events. In other words, these models are designed to extract temporal patterns within the medical history of a patient that are deemed related to the downstream task of risk prediction.

Real-world medical records have issues that degrade the performance of the current approach. In particular, the limited amount of labeled data which neither covers all possible combinations of medical events, nor covers all possible time durations between different events, undermine the effectiveness of the existing approach. In addition, in many cases, medical health records for a member are sometimes missing (e.g., a member drops his/her enrollment with UHG for a period of time). As a result, these non-active periods might be considered as an indication of “being healthy” and this would interfere with temporal patterns/signals that ML models will be trained on. Aspects of various embodiments of the present invention propose a novel framework to mitigate the impact of the noted shortcomings of the current approach.

Various embodiments of the present invention utilize two different views/representations of medical health records. One representation preserves temporal information (i.e., preserves medical events, their order, and time durations between them). The second, non-temporal representation preserves the presence of medical events without preserving the order of these events, and without preserving time durations between them. To illustrate the different between these two representations, for example, consider a medical history that consist of events A, B and C. The first representation would preserve that event A comes at time t_1, then it is followed by event B at time t_2, and then comes event C at time t_3. Meanwhile, the second representation only preserves that events A, B, and C are present in the history. If another member has the same events in different order (for example, C B A), the first representation of this medical history would be different while the second representation should remain unchanged.

Each of these representations is then used to train a ML model to achieve the downstream task of risk prediction. The reason behind this step is to allow ML models to extract different types of patterns related to risk prediction. The ML model utilizing the first representation focuses on extracting temporal patterns, while the other ML model extracts co-occurrence patterns. In other words, this invention looks at the same medical health records from two different perspectives and allows ML models to better utilize available labeled datasets. Risk scores generated using the 2 branches above are then fused/combined to produce final risk scores.

To show the value gained using the Disease Progression Framework concepts, a model using two ML branches was developed. Both ML branches are trained using the same dataset (yet different representations). The first branch utilizes all events present in the history (diagnosis codes, procedure codes, pharmacy codes, place of service codes), their order and their corresponding time. This branch is identical to risk prediction pipeline running in production. For the second branch, it is quite challenging to have a representation that represents all codes in the history without preserving their order and without preserving their time. However, some embodiments used visual Embeddings for medical History to encode input data for this branch.

### II. DEFINITIONS OF CERTAIN TERMS

The term “co-occurrence-based historical representation” may refer to an electronically-maintained data construct that is configured describes co-occurrences of a set of prediction input codes across a set of event data objects each describing an event, without describing the temporal relationships between the events corresponding to the sequence of event data objects. In some embodiments, given e event data objects, the co-occurrence-based historical representation is determined based at least in part on e event representations for the e event data objects. In some embodiments, given an event data object that is associated with d prediction input codes, the event representation for the event data object is determined based at least in part on code representations for the d prediction input codes of the particular event data object. In some embodiments, each prediction input code is associated with an event data object of a sequence of event data objects, the co-occurrence-based historical representation is determined based at least in part on each event representation for the sequence of event data objects, and each event representation is determined based at least in part on each code representation for a code subset of the sequence of prediction input codes that is associated with the event data object for the event representation. In some embodiments, the co-occurrence-based historical representation can be generated in accordance with at least one of techniques for generating historical representations that are disclosed in U.S. patent application Ser. No. 17/237,818 (filed Apr. 22, 2021), which is incorporated by reference herein in its entirety.

The term “temporal historical representation” may refer to an electronically-maintained data construct that is configured to describe temporal sequential relationship between occurrences of the sequence of prediction input codes. For example, in some embodiments, the temporal representation of a sequence of prediction input codes each having a timestamp is generated by: (i) for each prediction input code, processing (e.g., using a machine learning model) the prediction input code and a temporal encoding representation of the timestamp to generate a temporal code representation for the prediction input codes, and (ii) aggregating the temporal code representations for the sequence of prediction input codes to generate the temporal representation of the sequence of prediction input codes. In some embodiments, a sequence of prediction input codes is processed by a timeseries processing machine learning model to generate the temporal representation of the sequence of prediction input codes.

The term “co-occurrence-based prediction machine learning model” may refer to an electronically stored data construct that is configured to describe parameters, hyper-parameters, and/or stored operations of a machine learning model that is configured to process a co-occurrence-based historical representation of a sequence of prediction input codes associated with a predictive entity to generate the co-occurrence-based prediction for the predictive entity. For example, the co-occurrence-based prediction machine learning model may comprise one or more fully connected layers that are collectively configured to process a co-occurrence-based historical representation of a sequence of prediction input codes associated with a predictive entity to generate the co-occurrence-based prediction for the predictive entity. In some embodiments, inputs to the co-occurrence-based prediction machine learning model comprise one or more vectors corresponding to the co-occurrence-based historical representation, while outputs of the co-occurrence-based prediction machine learning model comprise one or more vectors and/or one or more atomic values corresponding to the co-occurrence-based prediction output. For example, in some embodiments, the outputs of the co-occurrence-based prediction machine learning model may include a vector having v values, where each vector value describes a predicted likelihood that the predictive entity is associated with a diagnosis that is associated with the vector value.

The term “temporal prediction machine learning model” may refer to an electronically stored data construct that is configured to describe parameters, hyper-parameters, and/or stored operations of a machine learning model that is configured to process a temporal historical representation of a sequence of prediction input codes associated with a predictive entity to generate the temporal prediction for the predictive entity. For example, the temporal prediction machine learning model may comprise one or more fully connected layers that are collectively configured to process a temporal historical representation of a sequence of prediction input codes associated with a predictive entity to generate the temporal prediction for the predictive entity. In some embodiments, inputs to the temporal prediction machine learning model comprise one or more vectors corresponding to the temporal historical representation, while outputs of the temporal prediction machine learning model comprise one or more vectors and/or one or more atomic values corresponding to the temporal prediction output. For example, in some embodiments, the outputs of the temporal prediction machine learning model may include a vector having v values, where each vector value describes a predicted likelihood that the predictive entity is associated with a diagnosis that is associated with the vector value.

The term “hybrid prediction score” may refer to an electronically stored data construct that is configured to a predictive output generated based at least in part on a co-occurrence-based prediction score and a temporal prediction score. In some embodiments, to generate the hybrid prediction score, the co-occurrence-based prediction score and the temporal prediction score are processed by a machine learning model (e.g., a machine learning model including one or more fully connected layers) to generate an output that can then be used to generate the hybrid prediction score. In some embodiments, the hybrid prediction score includes a vector having v values, where each vector value describes a predicted likelihood that the predictive entity is associated with a diagnosis that is associated with the vector value.

The terms “event” or “event data object” may refer to may refer to an electronically-maintained data construct that is configured to describe one or more prediction input codes pertaining to a recorded event, such as one or more clinical codes associated with a medical visit event by a user. In some embodiments, an event may describe a clinical event. For example, an event may describe a healthcare visit, a diagnosis for a user during a healthcare visit, a pharmaceutical purchase visit, or the like. In some embodiments, each event may be associated with a date data object indicative of when the event occurred.

The term “prediction input code” may refer to an electronically-maintained data construct that is configured to describe a unit of categorical data pertaining to an event. In some embodiments, the prediction input code may be indicative of a diagnosis code for an event, a procedure code for an event, a pharmacy code for an event, or the like. In some embodiments, the prediction input code may be an International Classification of Disease (ICD) code, a hierarchical ingredient code (HIC), a Current Procedural Terminology (CPT) code, and/or the like. In some embodiments, a prediction input code may comprise a plurality of character patterns for a plurality of character pattern positions.

The term “character pattern position” may refer to an electronically managed data construct that is configured to describe a particular set of characters in the prediction input codes having a particular prediction input code type, where the particular set of characters are defined by a position of the particular set of characters within the prediction input codes having the particular prediction input code type. For example, given the prediction input codes having an ICD code prediction input code type, the first character of an ICD code may have a first character pattern position, a second character of an ICD code may have a second character pattern position, and so on. Accordingly, given the ICD code “A53,” an associated first character pattern position may comprise the character pattern corresponding to the first digit (i.e., “A”), the second character pattern position may comprise the character pattern corresponding to the second digit (i.e., “5”), and the third character position may comprise the character pattern corresponding to the third digit (i.e., “3”). In some embodiments, each character pattern position for a group of prediction input codes having a particular prediction input code type may be associated with a set of candidate character patterns. For example, for the first character position of an ICD code, the plurality of candidate character patterns may include “A,” “B,” “C,” or “D,” while, for each of the second character position and third character positions for an ICD code, the plurality of candidate character patterns may include a number between 1 to 9.

The term “image channel representation” may refer to an electronically managed data construct that is configured to describe, given a corresponding prediction input code having a plurality of character patterns for a plurality of character pattern positions, a plurality of image channel representation regions corresponding to the plurality of candidate character patterns for a corresponding character pattern position of the plurality of character pattern positions, where an image channel representation region corresponding to the character pattern for the corresponding prediction input code with respect to the corresponding prediction input code is visually distinguished. For example, for the prediction input code “A53,” the first character pattern position of the prediction input code that is associated with the character pattern A may be associated with an image channel representation that is divided into four image channel representation regions (because the first character pattern position is associated with four candidate character patterns may include “A,” “B,” “C,” or “D”), where an image channel representation region corresponding to the candidate character pattern “A” is visually distinguished (e.g., by marking the an image channel representation region corresponding to the candidate character pattern “A” with a particular color. In some embodiments, the plurality of image channel representations may be associated with an image channel order. The image channel order may be determined based at least in part on a character pattern position order of the plurality of character patterns. For example, for an ICD code, the image channel representation corresponding to the first character pattern position of the ICD code may have a lower-ordered position relative to the image channel representation corresponding to the second character position. In some embodiments, each image channel representation may have an associated channel size dimension data object. The channel size data object may be indicative of the number of pixels corresponding to the length and width of the image channel representation, the number of image channel representation regions of the image channel representation, and/or the number of dimensions of each image channel representation region of the image channel representation.

The term “image channel representation region” may refer to an electronically managed data construct that is configured to describe a region of an image character representation for a corresponding character pattern position that corresponds to a candidate character pattern for the character pattern position. The image channel representation region may correspond to a particular candidate character pattern for the particular character pattern position associated with the image channel representation. The number of image channel representation regions may be determined based at least in part on the number of candidate character patterns for a particular character pattern position. In some embodiments, the visual representation of the image channel representation region may be indicative of whether the corresponding candidate character pattern is present or absent in an associated character pattern position of an associated prediction input code. For example, in some embodiments, a white value for the image channel representation region may be indicative of the presence of the corresponding candidate character pattern in the prediction input code. As another example, in some embodiments, a black value for the image channel representation region may be indicative of the absence of the corresponding candidate character pattern in the prediction input code.

The term “expanded representation” may refer to an electronically managed data construct that configured to describe a prediction input code, where each image channel representation for the prediction input code is integrated into an image channel representation for a predecessor image channel representation for the image channel representation as determined based at least in part on the image channel order for the prediction input code. The expanded representation may comprise a plurality of image channel representations, each associated with a character pattern position of the plurality of character pattern positions of the prediction input code. In some embodiments, an expanded event representation may be generated by utilizing a channel aggregation machine learning model. In some embodiments, generating an expanded representation of a prediction input code includes: determining a low-ordered subset of the plurality of image channel representations for the prediction input codes that comprises all of the plurality of image channel representations except a highest-ordered image channel representation as determined based at least in part on the image channel order (e.g., for the prediction input code “A53,” a low-ordered subset that includes the image channel representation for “A” and the image channel representation for “5”); for each image channel representation in the low-ordered subset that is selected in accordance with the image channel order starting with an in-subset highest-ordered image channel representation in the low-ordered subset (e.g., for the low-ordered subset that includes the image channel representation for “A” and the image channel representation for “5,” starting with the -subset highest-ordered image channel representation corresponding to the image character representation for “5”): (a) identifying a successor image channel representation of the plurality of image channel representations for the image channel representation based at least in part on the image channel order (e.g., for the image channel representation for “5,” the successor image channel representation for “3”), (b) updating a channel size dimension data object for the image channel representation based at least in part on a successor channel size dimension data object for the predecessor image channel representation; and (c) updating the image channel representation by resizing image channel representation for the image channel representation based at least in part on the channel size dimension data object (e.g., updating the image channel representation for “5” so the image channel representation for “5” can integrate nine of the image channel representation for “3,” given the count of candidate character patterns for the character pattern position associated with “3” is nine); determining a high-ordered subset of the plurality of image channel representations that comprises all of the plurality of image channel representations except a lowest-ordered image channel representation of the plurality of image channel representations as determined based at least in part on the image channel order (e.g., for the prediction input code “A53,” a high-ordered subset that includes the image channel representation for “5” and the image channel representation for “3”); and for each image channel representation in the high-ordered subset starting with an in-subset lowest-ordered image channel representation in the high-ordered subset (e.g., for the high-ordered subset that includes the image channel representation for “5” and the image channel representation for “3,” starting with the in-subset lowest-ordered image channel representation corresponding to “5”): (a) generating an image location for the image channel representation in the lowest-ordered image channel representation based at least in part on each predecessor image channel representation for the image channel representation as determined based at least in part on the image channel order, and (b) updating the image channel representation by integrating the image channel representation into the lowest-ordered image channel representation in accordance with the image location.

The term “expanded event representation” may refer to an electronically managed data construct that is configured to describe a representation of an event that is determined based a set of image channel representations for a particular character pattern position of the prediction input code for the event. For example, given an event that is associated with five ICD codes for a clinical visit event, each character pattern position of the five ICD codes may be associated with an expanded event representation that is generated by processing the image channel representations for the character pattern positions using a channel aggregation machine learning model. In an exemplary scenario, if the five ICD codes include “A22,” “B33,” “C32,” “D56,” and “F88,” then the expanded event representation for the first character position may be generated by processing the following using a channel aggregation machine learning model: the image channel representation for “A,” the image channel representation for “B,” the image channel representation for “C,” the image channel representation for “D,” and the image channel representation for “F.” In some embodiments, the set comprising the image channel representation for “A,” the image channel representation for “B,” the image channel representation for “C,” the image channel representation for “D,” and the image channel representation for “F” is referred to as a “co-ordered channel subset,” as all of the noted image channel representations are associated with character patterns having a common character pattern position.

The term “per-channel representation segment” may refer to an electronically managed data construct that is configured to describe a subset of expanded event representations for a set of events that correspond to a common character pattern position. For example, given a clinical visit event that is associated with five ICD codes, where the five ICD codes include “A22,” “B33,” “C32,” “D56,” and “F88,” then as discussed above the expanded event representation for the first character position of the clinical visit event may be generated by processing the following using a channel aggregation machine learning model: the image channel representation for “A,” the image channel representation for “B,” the image channel representation for “C,” the image channel representation for “D,” and the image channel representation for “F.” Now, consider further that the clinical visit event may be one of n clinical visit events, each of which may be associated with an expanded event representation for the first character position. In this example, the set of all expanded event representations for the first character pattern position may be grouped together as part of a per-channel representation segment. In some embodiments, because a set of events may be associated with a temporal order (e.g., as determined based at least in part on a time ordering of clinical visits), then each per-channel representation segment for the set of events may also be associated with a temporal order, such that each expanded event representation in the per-channel representation segment is associated with a temporally precedent subsegment of the per-channel representation segment. For example, given a set of three ordered events E1, E2, and E3, then the per-channel representation segment for a first character pattern position of the set of three ordered events may be ordered such that the temporally precedent subsegment for the expanded event representation for E2 in a per-channel representation segment for a first character pattern position may consist of E1. As another example, given a set of three ordered events E1, E2, and E3, then the per-channel representation segment for a first character pattern position of the set of three ordered events may be ordered such that the temporally precedent subsegment for the expanded event representation for E2 in a per-channel representation segment for a first character pattern position may consist of E1 and E2.

The term “cumulative expanded representation” may refer to an electronically managed data construct that is configured to describe a representation of an image channel representation of a prediction input code, where representation is determined based at least in part on a temporally precedent subsegment of the per-channel representation segment for a character pattern position of the particular image channel representation. For example, given an image channel representation that is associated with the mth character pattern position of an nth event, the cumulative expanded representation may be determined based at least in part on all expanded event representations for the mth character pattern position that correspond to the events {1, . . . , n}. As another example, given an image channel representation that is associated with the mth character pattern position of an nth event, the cumulative expanded representation may be determined based at least in part on all expanded event representations for the mth character pattern position that correspond to the events {1, . . . , n}. In some embodiments, the events may be associated with an associated event order. As such, the cumulative expanded representation may be generated for a prediction input code based at least in part on a temporally precedent subsegment of a channel representation segment such that the prediction input code and one or more prediction input codes temporally precedent are included in the cumulative expanded representation. In some embodiments, the cumulative expanded representation may correspond to a particular event such that the cumulative expanded representation describes one or more prediction input code associated with said event.

The term “compact event representation” may refer to an electronically managed data construct configured to describe a representation of an event that is determined based at least in part on processing all of the expanded representations in the expanded representation for the event using a feature aggregation machine learning model. For example, given an event that is associated with a set of three-character ICD codes and thus has three expanded representations in the expanded event representation for the event, the three expanded representations may be processed using a feature aggregation machine learning model in order to generate the compact event representation for the particular event. The compact event representation may aggregate the plurality of image channel representations into a single image representation. In some embodiments, this may be accomplished via a feature aggregation machine learning model.

The term “cumulative compact event representation” may refer to an electronically managed data construct configured to describe an event in a set of ordered events based at least in part on the compact event representations in a predecessor subset of the set of ordered events. For example, given a set of ordered events {E1, E2, E3} (where E1 is deemed to occur prior to E2 and E2 deemed to occur prior to E3), then the cumulative compact event representation for E2 may be determined based at least in part on the compact event representations in a predecessor subset for E2 (which may consist of E1 or consist of E2 and E3, depending on the embodiment).

The term “channel aggregation machine learning model” may refer to an electronically stored data construct that is configured to describe parameters, hyper-parameters, and/or stored operations of a machine learning model that is configured to process a co-ordered channel set for an image channel representation to generate an expanded event representation for the image channel representation. In some embodiments, the channel aggregation machine learning model may process the plurality image channel representations described by the co-ordered channel set and perform one or more mathematical or logical operations on the plurality of expanded representations to generate an expanded event representation.

The term “feature aggregation machine learning model” may refer to an electronically stored data construct that is configured to describe parameters, hyper-parameters, and/or stored operations of a machine learning model configured to process a plurality of expanded representations for a set of events to generate a compact event representation for an event among the set of events. In some embodiments, the feature aggregation machine learning model may process the plurality of expanded representations and perform one or more mathematical or logical operations on the plurality of expanded representations to generate a compact event representation.

The term “feature type aggregation machine learning model” may refer to an electronically stored data construct that is configured to describe parameters, hyper-parameters, and/or stored operations of a machine learning model that is configured to process a plurality of cumulative compact event representations to generate a co-occurrence-based historical representation. In some embodiments, the plurality of cumulative compact event representations may each correspond to a prediction input code type (i.e., a type of structured text input feature). In some embodiments, the feature type aggregation machine learning model may process the plurality of cumulative compact event representations and perform one or more mathematical or logical operations on the plurality of expanded representations to generate a cumulative compact event representation.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

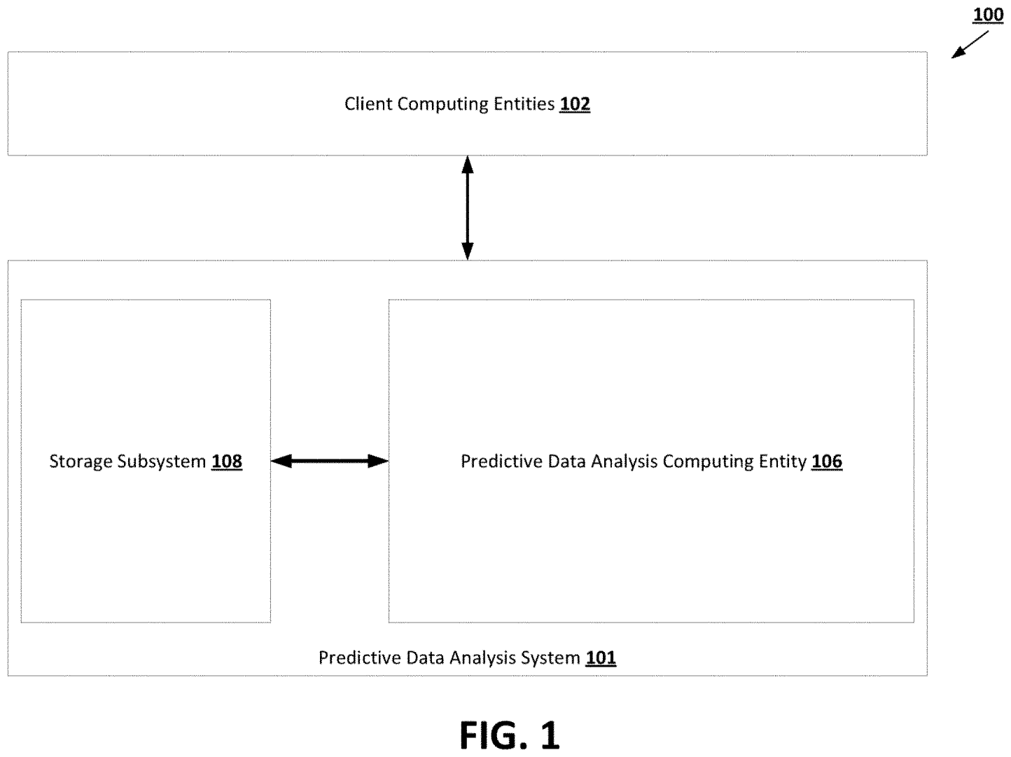

FIG. 1 is a schematic diagram of an example architecture 100 for performing predictive data analysis with respect to categorical data objects. The architecture 100 includes a predictive data analysis system 101 configured to receive predictive data analysis requests from external computing entities 102, process the predictive data analysis requests to generate predictive outputs, provide the generated predictive outputs to the external computing entities 102, and automatically perform prediction-based actions based at least in part on the generated predictive outputs.

Examples of predictive data analysis requests that may be processed by the predictive data analysis system 101 include generating a recommendation score for each medication/treatment regimen of a set of candidate medication/treatment regimens for a particular patient identifier, generating one or more diagnosis scores, and/or the like.

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive structured data predictive data analysis requests from one or more external computing entities 102, process the predictive data analysis requests to generate the predictions corresponding to the predictive data analysis requests, provide the generated predictions to the external computing entities 102, and automatically perform prediction-based actions based at least in part on the generated predictions.

The storage subsystem 108 may be configured to store input data used by the predictive data analysis computing entity 106 to perform predictive data analysis tasks as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

A. Exemplary Predictive Data Analysis Computing Entity

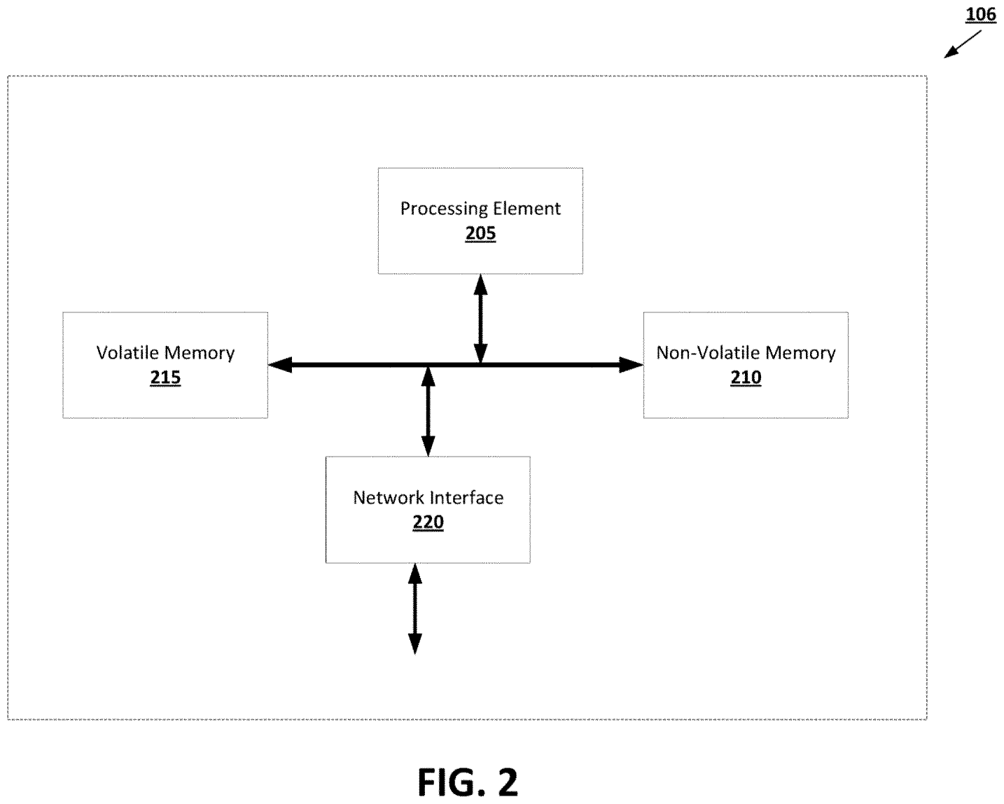

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 200 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include or be in communication with one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 190, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 200 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include or be in communication with one or more input elements, such as a keyboard input, a mouse input, a touch screen/display input, motion input, movement input, audio input, pointing device input, joystick input, keypad input, and/or the like. The predictive data analysis computing entity 106 may also include or be in communication with one or more output elements (not shown), such as audio output, video output, screen/display output, motion output, movement output, and/or the like.

B. Exemplary External Computing Entity

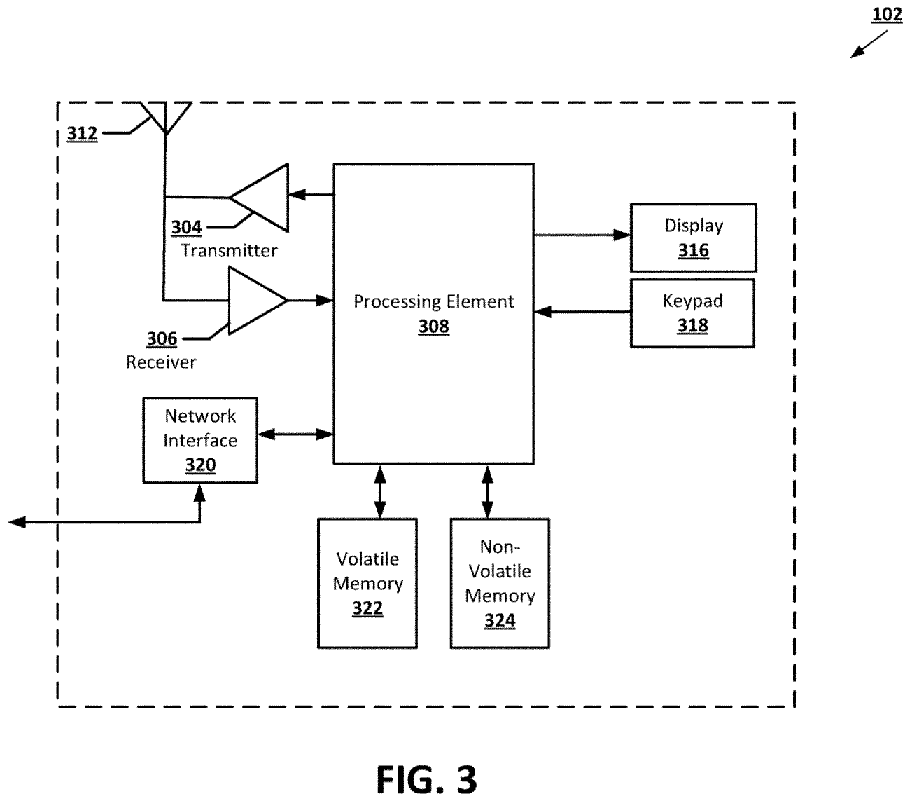

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

As described below, various embodiments of the present invention address operational efficiency and operational reliability of predictive data analysis systems that are configured to perform predictive data analysis operations with respect to input data entities that describe temporal relationships across a large number of prediction input codes. For example, various embodiments of the present invention improve accuracy of predictive outputs generated based at least in part on input data entities that describe temporal relationships across a large number of prediction input codes by using hybrid prediction scores that are determined based at least in part on co-occurrence-based prediction scores and temporal prediction scores, where the co-occurrence-based prediction scores are determined based at least in part on co-occurrence-based historical representation of a sequence of prediction input codes and temporal historical representation of the sequence of prediction input codes. Improving accuracy of predictive output in turn: (i) decreases the number of computational operations performed by processing units of predictive data analysis systems, thus increasing the computational efficiency of predictive data analysis systems, (ii) decreases the overall likelihood of system failure given a constant per-recommendation likelihood failure, thus increasing operational reliability of predictive data analysis systems, and (iii) increases the overall number of end-users that the predictive data analysis system can serve given a constant per-user query count, thus increasing the operational throughput of predictive data analysis systems. Accordingly, various embodiments of the present disclosure make important technical contributions to the field of predictive data analysis by improving computational efficiency, operational reliability, and operational throughput of predictive data analysis systems.

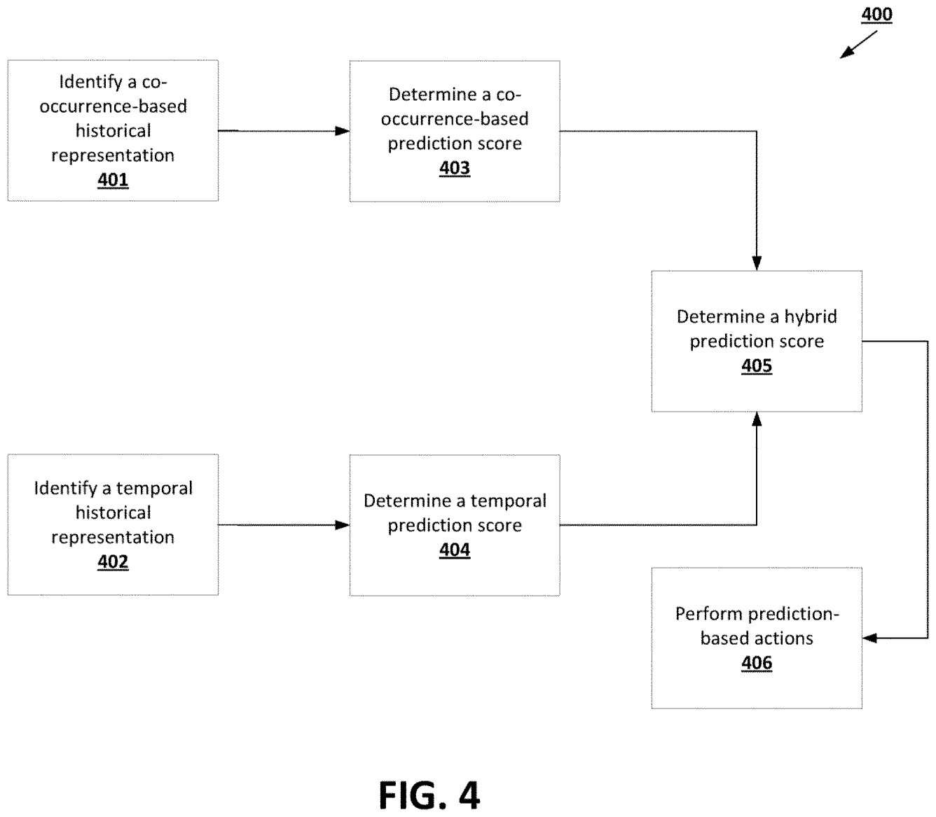

FIG. 4 is a flowchart diagram of an example process 400 for determining a hybrid prediction score for a predictive entity that is associated with a sequence of prediction codes (e.g., a patient/member predictive entity that is associated with a sequence of prediction input codes comprising diagnosis codes, procedure codes, and/or the like). Via the various steps/operations of the process 400, the predictive data analysis computing entity 106 can use both co-occurrence-based inferences and temporal inferences to generate predictive data analysis outputs.

The process 400 begins at step/operation 401 when the predictive data analysis computing entity 106 identifies a co-occurrence-based historical representation of the sequence of prediction input codes. In some embodiments, each prediction input code is associated with an event data object of a sequence of event data objects, the co-occurrence-based historical representation is determined based at least in part on each event representation for the sequence of event data objects, and each event representation is determined based at least in part on each code representation for a code subset of the sequence of prediction input codes that is associated with the event data object for the event representation. In some embodiments, the co-occurrence-based historical representation can be generated in accordance with at least one of techniques for generating historical representations that are disclosed in U.S. patent application Ser. No. 17/237,818 (filed Apr. 22, 2021), which is incorporated by reference herein in its entirety.

In some embodiments, a co-occurrence-based historical representation describes co-occurrences of a set of prediction input codes across a set of event data objects each describing an event, without describing the temporal relationships between the events corresponding to the sequence of event data objects. In some embodiments, given e event data objects, the co-occurrence-based historical representation is determined based at least in part on e event representations for the e event data objects. In some embodiments, given an event data object that is associated with d prediction input codes, the event representation for the event data object is determined based at least in part on code representations for the d prediction input codes of the particular event data object.

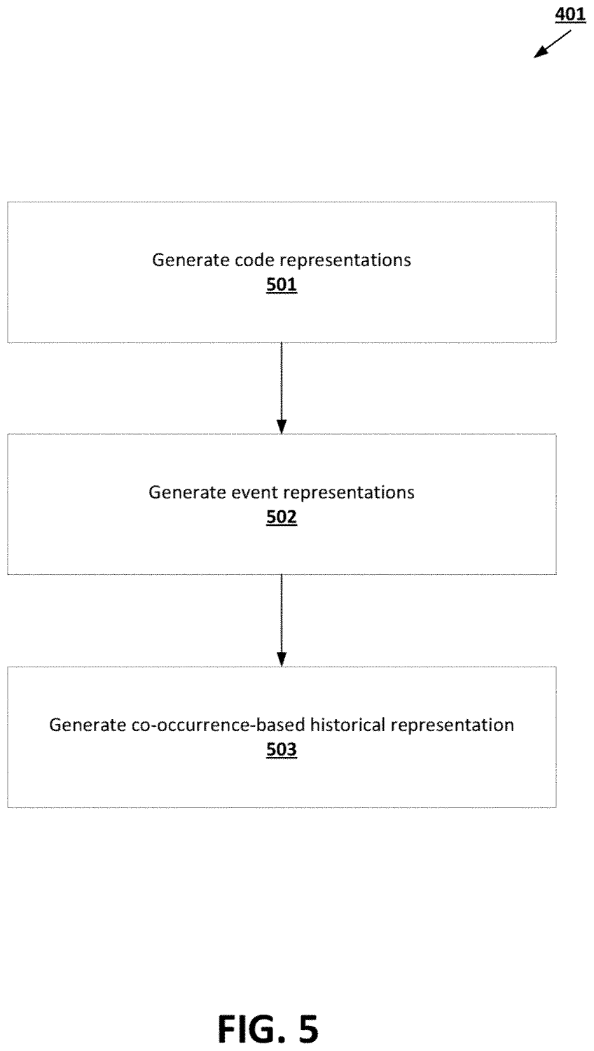

In some embodiments, step/operation 401 may be performed in accordance with the process that is depicted in FIG. 5. The process that is depicted in FIG. 5 begins at step/operation 501 when the predictive data analysis computing entity 106 generates a code representation for each prediction input code in the sequence of prediction input codes.

In some embodiments, given a prediction input code that has n character pattern positions, the code representation for the prediction input code has m image channel representations, where each character pattern position is associated with one of the m image channel representations. For example, given n=m, each character position may be associated with a distinctive image channel representation. In an exemplary embodiment, given n=m, and given the prediction input code “A53,” a first image channel representation may be used to depict a visualization corresponding to the character pattern “A” that corresponds to the first character pattern position, a second image channel representation may be used to depict a visualization corresponding to the character pattern “5” that corresponds to the first character pattern position, and a third image channel representation may be used to depict a visualization corresponding to the character pattern “3” that corresponds to the third character pattern position.

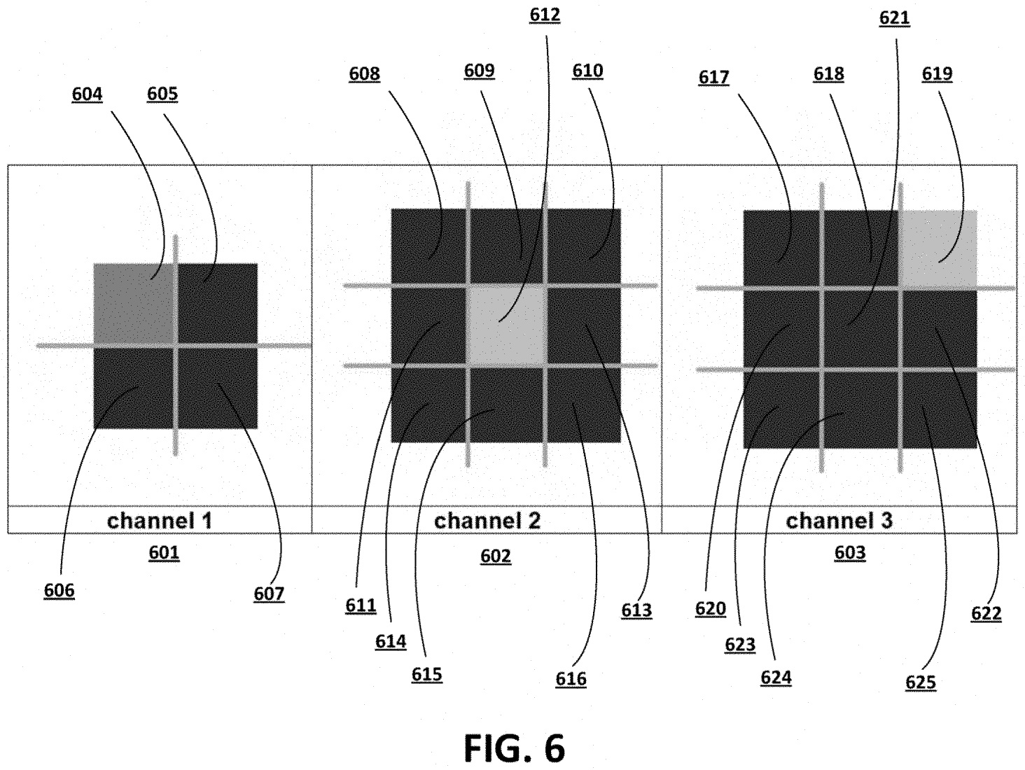

An operational example of three image channel representations 601-603 that corresponds to the prediction input code “A53” is depicted in FIG. 6. As depicted in FIG. 6, the first image channel representation 601 that is associated with the first character pattern position is divided into four image channel representation regions 604-607 because the first character pattern position can only take one of four values {A, B, C, D}, the second image channel representation 602 that is associated with the second character pattern position is divided into nine image channel representation regions 608-616 because the second character pattern position can only take one of nine values {1, 2, 3, 4, 5, 6, 7, 8, 9}, and the third image channel representation 603 that is associated with the second character pattern position is divided into nine image channel representation regions 617-625 because the third character pattern position can only take one of nine values {1, 2, 3, 4, 5, 6, 7, 8, 9}.

As further depicted in FIG. 6, in the first image channel representation 601, the image channel representation region 604 that corresponds to the value “A” is visually distinguished by a grayscale transformation. Furthermore, as further depicted in FIG. 6, in the second image channel representation 602, the image channel representation region 612 that corresponds to the value “5” is visually distinguished by a grayscale transformation. Moreover, as further depicted in FIG. 6, in the third image channel representation 603, the image channel representation region 619 that corresponds to the value “3” is visually distinguished by a grayscale transformation.

In some embodiments, the m image channel representations have an image channel order that is defined by the order of character patterns of the prediction input code (i.e., the character pattern position order of the prediction input code) corresponds to the m image channel representations in the predictive input code. For example, according to the image channel order of FIG. 6, the image channel representation 601 has the lowest image channel order, the image channel representation 602 has the second lowest image channel order, and the image channel representation has the highest image channel order. In some embodiments, given an ith ordered image channel representation, the (i+1)th image channel representation (if it exists) is deemed to be the successor image channel representation for the ith ordered image channel representation, while the (i−1)th image channel representation (if it exists) is deemed to be the predecessor image channel representation for the ith ordered image channel representation. For example, according to the image channel order of FIG. 6, the image channel representation 601, the image channel representation 601 is the predecessor to the image channel representation 602, while the image channel representation 602 is the successor of the image channel representation 601.

Once m image channel representations for a prediction input code are generated, they can be used in various potential ways to generate the code representation for the prediction input code. For example, in some embodiments, the predictive data analysis computing entity 106 first determines a low-ordered subset of the m image channel representations that include all of the m image channel representations except the highest ordered image channel representation. For example given the operational example of FIG. 6, the low-ordered subset includes the image channel representations 601-602 but not the image channel representation 603. Afterward, the predictive data analysis computing entity 106 performs the following operations for each image channel representation of the m−1 image channel representations in the low-ordered subset starting with an in-subset highest-ordered image channel representation in the low-ordered subset (e.g., in the operational example of FIG. 6, starting with the second image channel representation 602 and then proceeding to the first image channel representation 601): (i) identifying a successor image channel representation of the m channel representations for the image channel representation based at least in part on the image channel order, (ii) updating a channel size dimension data object for the image channel representation based at least in part on a successor channel size dimension data object for the predecessor image channel representation, and (iii) updating the image channel representation by resizing image channel representation for the image channel representation based at least in part on the channel size dimension data object.

Thereafter, the predictive data analysis computing entity 106 determines a high-ordered subset of the m image channel representations that comprises all of the m image channel representations except a lowest-ordered image channel representation of the m image channel representations as determined based at least in part on the image channel order. For example given the operational example of FIG. 6, the high-ordered subset includes the image channel representations 602-603 but not the image channel representation 601. Then, the predictive data analysis computing entity 106 performs the following operations for each image channel representation of the m−1 image channel representations in the high-ordered subset starting with an in-subset lowest-ordered image channel representation in the high-ordered subset (e.g., in the operational example of FIG. 6, starting with the second image channel representation 602 and then proceeding to the third image channel representation 603): (i) generating an image location for the image channel representation in the lowest-ordered image channel representation based at least in part on each predecessor image channel representation for the image channel representation as determined based at least in part on the image channel order, and (iii) updating the image channel representation by integrating the image channel representation into the lowest-ordered image channel representation in accordance with the image location.

In some embodiments, the operations described in the preceding two paragraphs ensure that each image channel representation fits into an image channel representation region of a predecessor image channel representation, which in turn ensures that (for example) the second image channel representation for the prediction input code “A52” and the second image channel representation for the prediction input code “D56” have different representations despite the fact that the second character position that corresponds to the second image channel representations is common across the two prediction input codes.

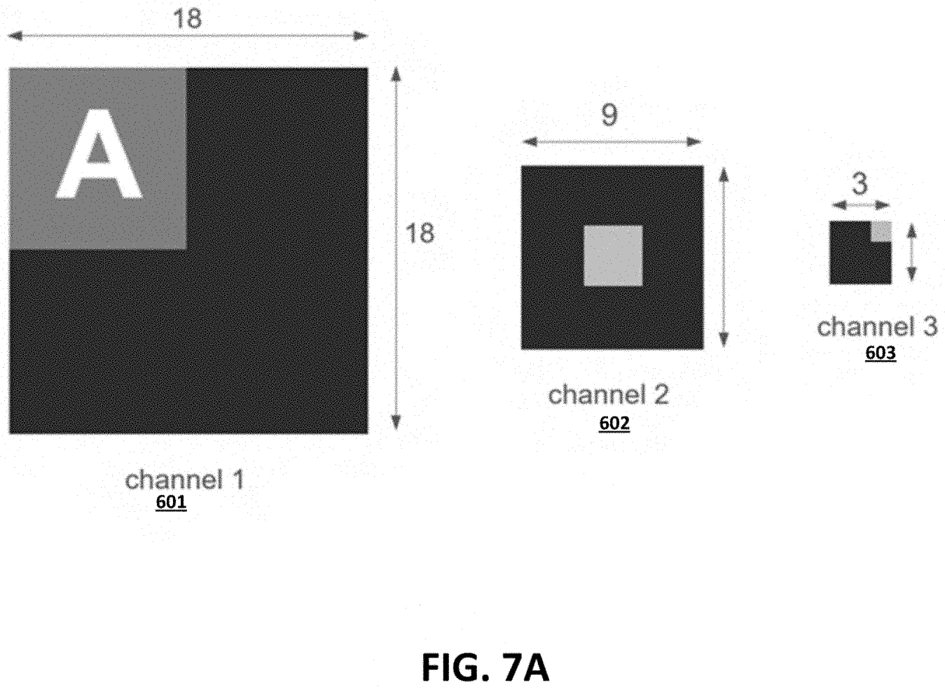

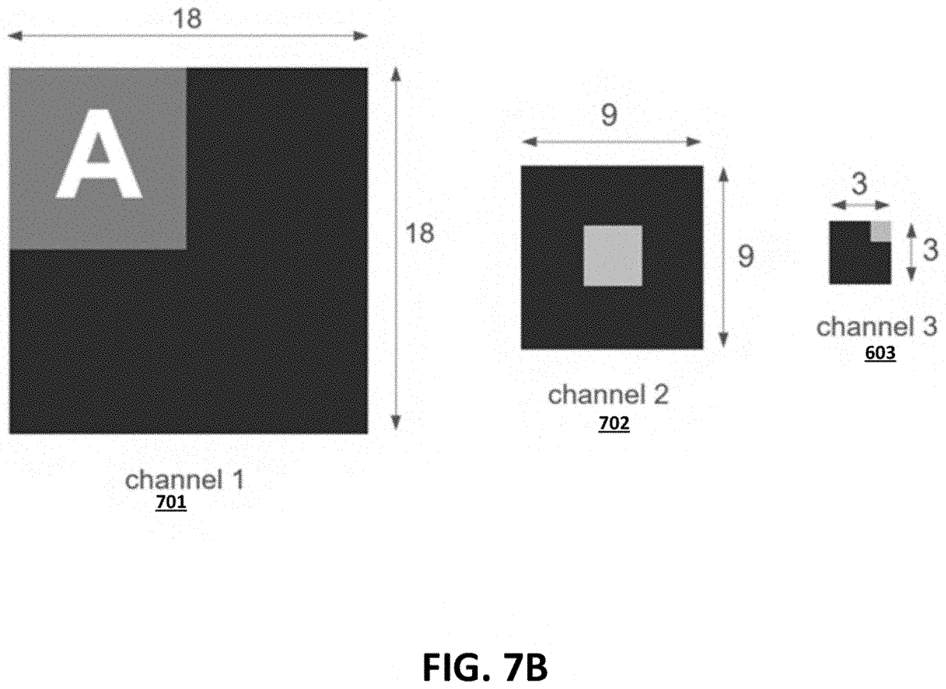

An operational example of the resizing operations described above can be seen in FIGS. 7A-7B. As depicted in FIG. 7A, prior to any resizing, the first image channel representation 601 has the dimensions 2*2, the second image channel representation 602 has the dimensions 3*3, and the third image channel representation has the dimensions image channel representation 3*3.

As depicted in FIG. 7B, after resizing of the image channel representations 601-603, the resized image channel representation 702 corresponding to the image channel representation 602 has the size 9*9, which ensures that the image channel representation 603 can fit into one of the image channel representations of the resized image channel representation 702. Moreover, as further depicted in FIG. 7B, after resizing of the image channel representations 601-603, the resized image channel representation 701 corresponding to the image channel representation 601 has the size 18*18, which ensures that the resized image channel representation 702 can fit into one of the image channel representations of the resized image channel representation 701.

As described above, in some embodiments, the image channel representation 603 can be integrated into a region of the resized image channel representation 702 that corresponds to the character pattern for the image channel representation 602 (e.g., in the operational example of FIG. 6, the region corresponding to “5”), and the resized image channel representation 702 can be integrated into a region of the resized image channel representation 701 that corresponds to the character pattern for the image channel representation 601 (e.g., in the operational example of FIG. 6, the region corresponding to “A”).

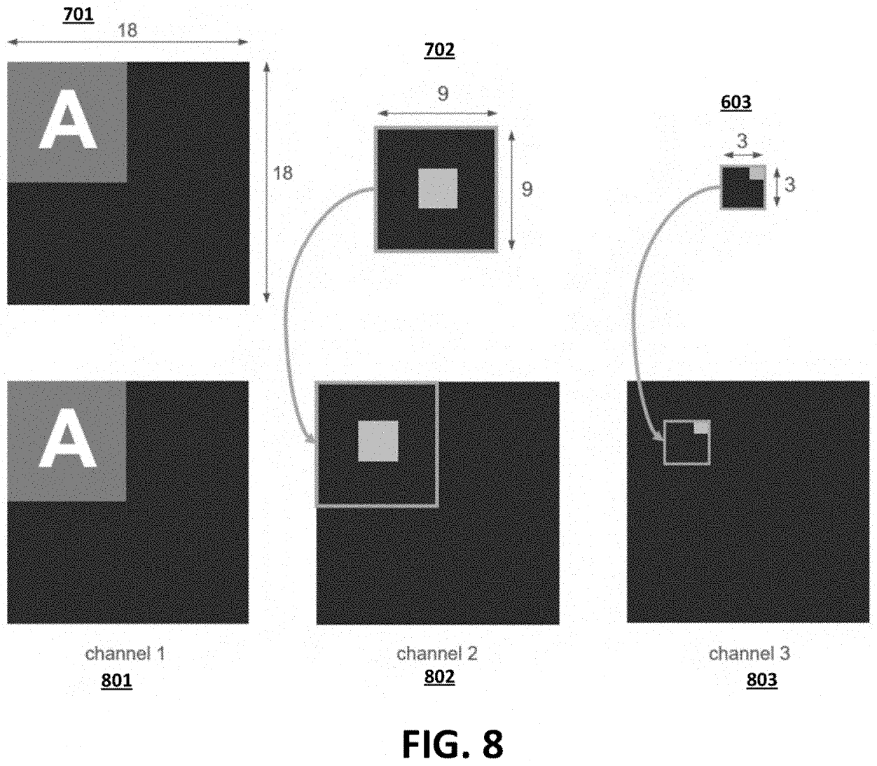

For example, as depicted in FIG. 8, the image channel representation 803 is a final representation of the third image channel representation 603 that is generated by: (i) integrating the third image channel representation 603 into a corresponding location of the resized image channel representation 702, and (ii) subsequently, integrating resized image channel representation 702 (which includes the third image channel representation 603) into the resized image channel representation 701. The result is that the image channel representation 803 contains a unique representation of a “3” character pattern that is followed by an “A5” character pattern. As further depicted in FIG. 8, the image channel representation 802 is a final representation of the third image channel representation 603 that is generated by integrating the resized image channel representation 702 into the resized image channel representation 701. The result is that the image channel representation 802 contains a unique representation of a “5” character pattern that is followed by an “A” character pattern.

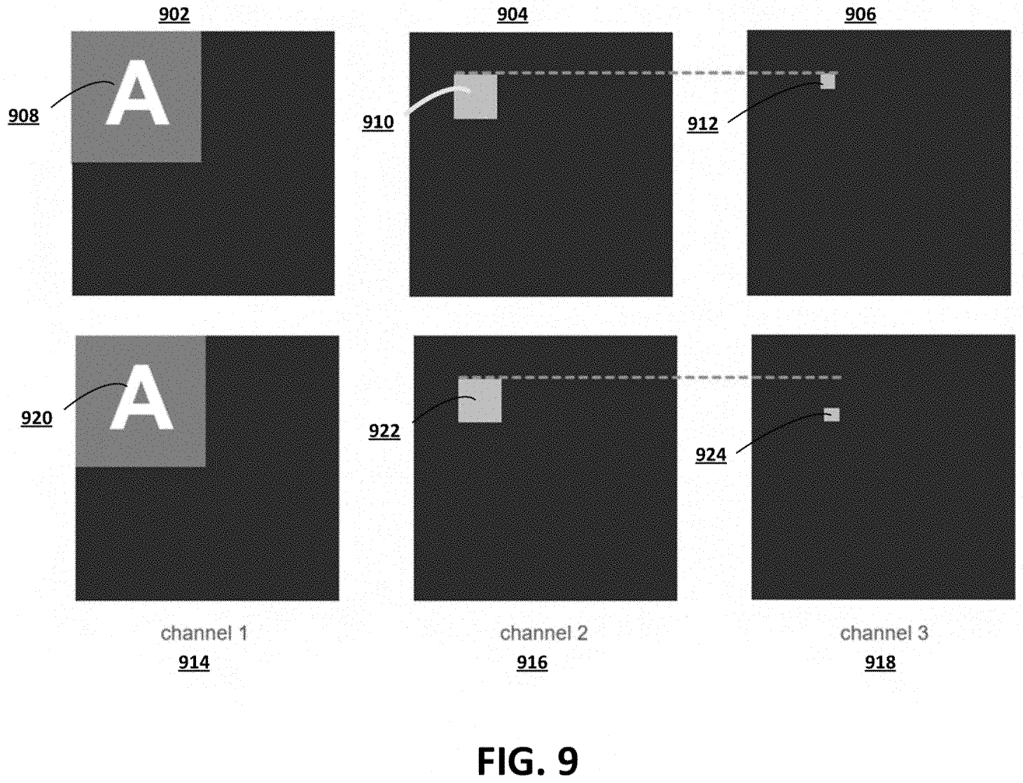

FIG. 9 depicts two image representations for two prediction input codes. The first image representation comprising first image channel representation 902, second image channel representation 904, and third image channel representation 906 corresponds to the prediction input code describing a structured text input feature “A53.” The second image representation comprising first image channel representation 914, second image channel representation 916, and third image channel representation 918 corresponds to the prediction input code describing a structured text input feature “A59.” Although the first image channel representations 902 and 914 and second image channel representations 904 and 916 describe the same character pattern “A” corresponding to the same image channel representation region (e.g., image channel representation regions 908 and 920) and “A5” corresponding to the same image channel representation region (e.g., image channel representation regions 910 and 922), the third image channel representations 906 and 918 differentiates the two image representations. The third image channel representation 906 corresponding to the first prediction input code describes an image channel representation region 912 that uniquely indicates the prediction input code “A53.” Similarly, the third image channel representation 918 corresponding to the second prediction input code describes an image channel representation region 924 that uniquely indicates the prediction input code “A59.” As such, the highest ordered image channel in the image representation may uniquely identify the prediction input code. Additionally, a machine learning model may also identify that the first image channel representation 902 and 914 and second image channel representation 904 and 916 corresponding to the two image representations are the same.

In some embodiments, a code representation includes m image channel representations, where each channel representation corresponds to one or more of the character pattern positions of the prediction input codes that are associated with the predictive input code. The m channel representations of c code representations in a sequence of c prediction input codes can then be combined in various ways to generate one or more event representations for the sequence.

Returning to FIG. 5, at step/operation 502, the predictive data analysis computing entity 106 generates an event representation for each event data object associated with the sequence of prediction input codes. In some embodiments, each prediction input code is associated with an event data object, such that the sequence of prediction input data objects may in some embodiments comprise a set of disjoints subsets each associated with an event data object of a set of event data objects. In some embodiments, the event representation for an event data object is determined based at least in part on code representations of those prediction input codes that are associated with the event data object.

In some embodiments, given an event data object that is associated with d prediction input codes, and given that each code representation includes m image channel representations, the event representation for the event data object may comprise m expanded event representation sets for the m image channel representations, where each of the m image channel representations is generated based at least in part on a co-ordered channel set that includes all of the image channel representations of the d prediction input nodes that are associated with a particular image channel representation. In some embodiments, the predictive data analysis computing entity 106 generates the expanded event representation for the an image channel representation by processing the co-ordered channel set for the image channel representation using a channel aggregation machine learning model. In some embodiments, the channel aggregation machine learning model may be a trained machine learning model that is configured to process each image channel representation of the co-ordered channel set for a particular image channel representation to generate an expanded event representation of the image channel representation. In some embodiments, the channel aggregation machine learning model may perform one or more mathematical or logical operations on the co-ordered channel subset for an image channel representation to generate the expanded event representation of the image channel subset.

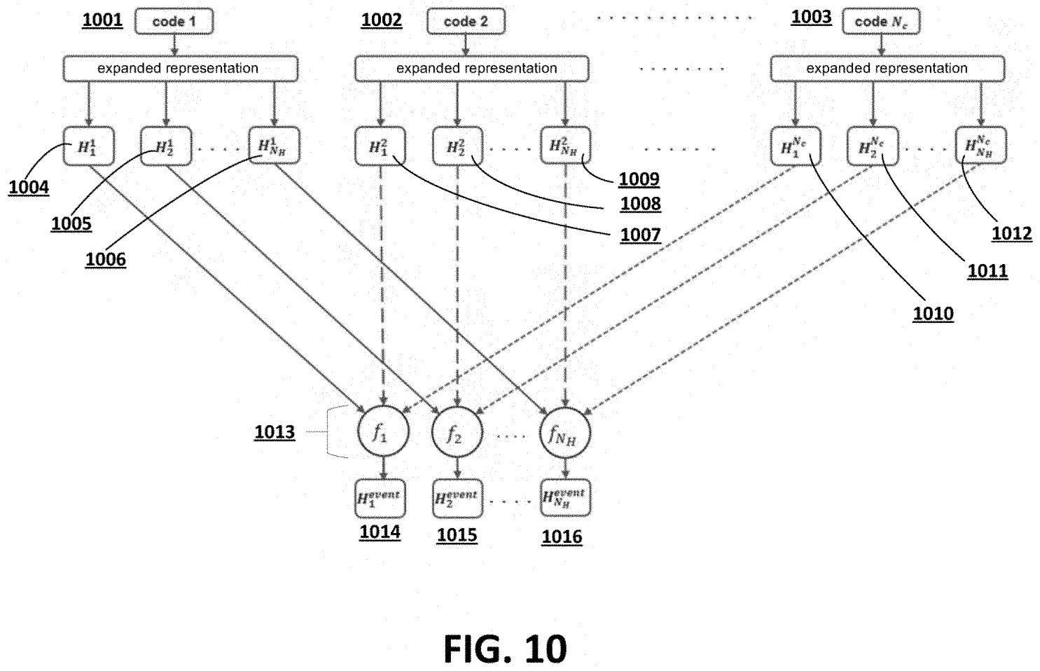

An operational example of generating the expanded event representations 1014-1016 for three image channel representations is depicted in FIG. 10. As depicted in FIG. 10, each prediction input code is used to generate a code representation that includes three image channel representations. For example, the first prediction input code 1001 is associated with a first image channel representation 1004, a second image channel representation 1005, and a third image channel representation 1006. As another example, the second prediction input code 1002 is associated with a first image channel representation 1007, a second image channel representation 1008, and a third image channel representation 1009. As yet another example, the third prediction input code 1003 is associated with a first image channel representation 1010, a second image channel representation 1011, and a third image channel representation 1012.

As further depicted in FIG. 10, the co-ordered channel subset for a first image channel representation include the first image channel representations 1004, the first image channel representation 1007, and the first image channel representation 1010. This co-ordered channel subset is then processed by a channel aggregation machine learning model 1013 to generate the expanded event representation 1014 for the first image channel representation with respect to an event data object that is associated with the three prediction input codes.

As further depicted in FIG. 10, the co-ordered channel subset for a second image channel representation include the second image channel representations 1005, the second image channel representation 1008, and the second image channel representation 1011. This co-ordered channel subset is then processed by the channel aggregation machine learning model 1013 to generate the expanded event representation 1015 for the second image channel representation with respect to an event data object that is associated with the three prediction input codes.

As further depicted in FIG. 10, the co-ordered channel subset for a third image channel representation include the third image channel representations 1006, the third image channel representation 1009, and the third image channel representation 1012. This co-ordered channel subset is then processed by the channel aggregation machine learning model 1013 to generate the expanded event representation 1016 for the third image channel representation with respect to an event data object that is associated with the three prediction input codes.

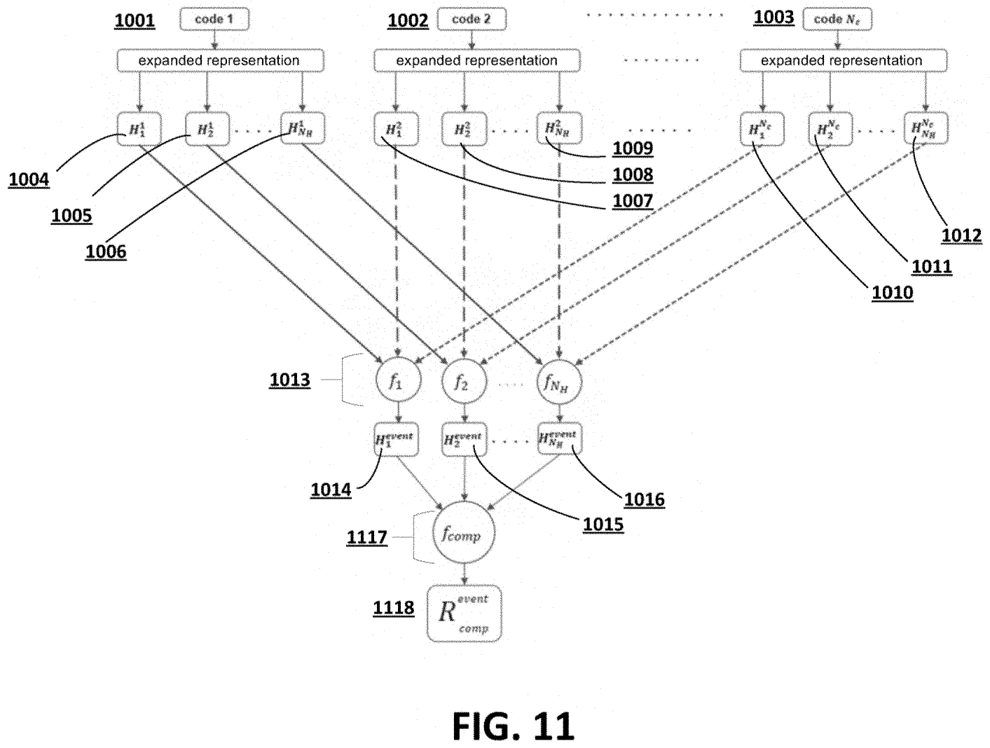

In some embodiments, the m expanded event representations for an event data object are adopted as the event representation for the event data object. In some embodiments, the m expanded event representations for an event data object are aggregated by a feature aggregation machine learning model (such as the feature aggregation machine learning model 1117 of FIG. 11) to generate a compact event representation (such as the compact event representation 1118 of FIG. 11) for the event data object, and the compact event representation is adopted as the event representation for the event data object.

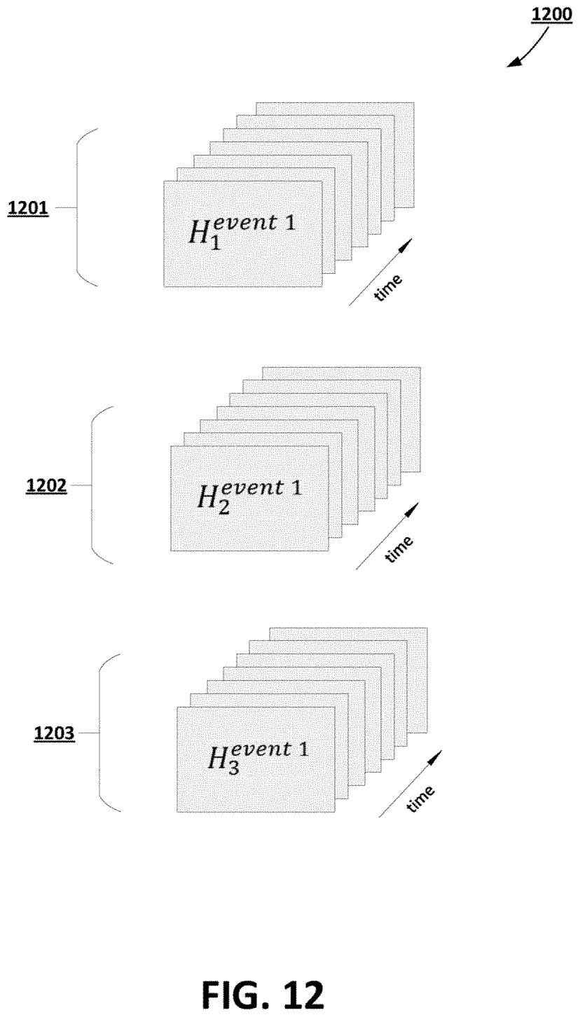

Returning to FIG. 5, at step/operation 503, the predictive data analysis computing entity 106 generates the co-occurrence-based historical representation based at least in part on each event representation for the group of event data objects associated with the predictive entity. In some embodiments, given e event data objects, where each event data object is associated with m expanded event representations for m image channel representations, the co-occurrence based historical representation includes m per-channel representation segments for the m image channel representations, where the per-channel representation segment for an image channel representation includes the e expanded event representations for the image channel representation across the e event data objects. For example, as depicted in FIG. 12, the co-occurrence-based historical representation 1200 includes the per-channel representation segment 1201 for a first image channel representation, the per-channel representation segment 1202 for a second image channel representation, and the per-channel representation segment 1203 for a third image channel representation.

In some embodiments, given e event data objects, where each event data object is associated with m expanded event representations for m image channel representations, the co-occurrence based historical representation includes m cumulative m per-channel representation segments for the m image channel representations, where each cumulative m per-channel representation segment for an image channel representation includes e cumulative expanded event representations for the image channel representation across the e event data objects. In some embodiments, the event data objects are associated with a temporal order, and the cumulative expanded event representation for a particular event data object and a particular image channel representation is determined based at least in part on a temporally precedent sub segment of the per-channel representation segment for the particular image channel representation and the particular event data object.

As noted above, given an image channel representation, the per-channel representation segment for the image channel representation may include each expanded event representation for the image channel representation for an event data object in the set of event data objects. If the set of event data objects is ordered, then the expanded event representations in the per-channel representation segment may similarly be ordered. For example, in an exemplary order, the expanded event representation for a first image channel representation and an event data object corresponding to Jan. 1, 2021 may occur before the expanded event representation for the first image channel representation and an event data object corresponding to Jan. 2, 2021 in the per-channel representation segment for the first image channel representation. Accordingly, since the per-channel representation segment may be an ordered set of expanded event representations, for a given event data object and a given image channel representation, the temporally precedent subsegment of the per-channel representation segment for the given image channel representation may be defined as a subset of the per-channel representation segment that includes all those expanded event representations who are ordered before the expanded event representation for the given event data object.

For example, given a per-channel representation segment that includes an expanded event representation for an event data object that is associated with Jan. 1, 2021, an expanded event representation for an event data object that is associated with Jan. 2, 2021, and an expanded event representation for an event data object that is associated with Jan. 3, 2021, the temporally precedent subsegment of the per-channel representation segment given the event data object that is associated with Jan. 2, 2021 may in some embodiments comprise exclusively the expanded event representation for the event data object that is associated with Jan. 1, 2021. As another example, given a per-channel representation segment that includes an expanded event representation for an event data object that is associated with Jan. 1, 2021, an expanded event representation for an event data object that is associated with Jan. 2, 2021, and an expanded event representation for an event data object that is associated with Jan. 3, 2021, the temporally precedent subsegment of the per-channel representation segment given the event data object that is associated with Jan. 2, 2021 may in some embodiments comprise exclusively the expanded event representation for the event data object that is associated with Jan. 1, 2021 as well as the expanded event representation for the event data object that is associated with Jan. 2, 2021.

In some embodiments, the temporally precedent subsegment of the per-channel representation segment for a particular image channel representation and a particular event data object is processed (e.g., by a machine learning model) to generate the cumulative expanded event representation that is associated with the particular image channel representation and the particular event data object. In some embodiments, given e event data objects, each of the e cumulative expanded event representations for the e event data objects that are associated with an ith image channel representation are used to generate a cumulative per-channel representation segment for the ith image channel representation. In some embodiments, given m image channel representations, the co-occurrence-based historical representation includes each cumulative per-channel representation segment for an image channel representation of the m image channel representations.

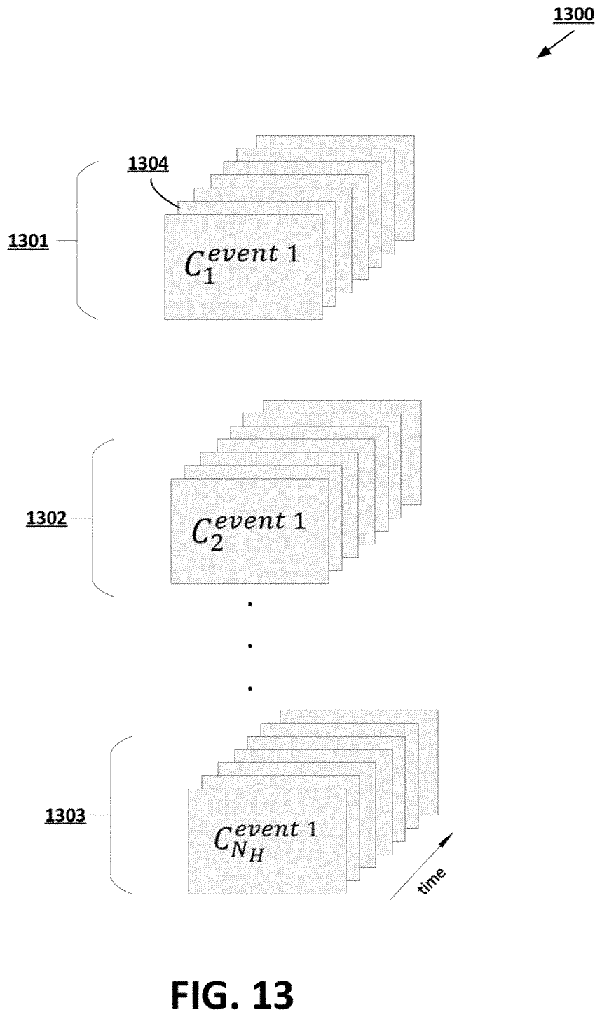

An operational example of a co-occurrence-based historical representation 1300 that comprises three cumulative per-channel representation segments 1301-1303 is depicted in FIG. 13. As depicted in FIG. 13, each cumulative per-channel representation segment 1301-1303 includes a set of cumulative expanded event representations that is determined based at least in part on a temporally precedent subsegment of the per-channel representation segment for a particular image channel representation and a particular event data object. For example, the cumulative event representation 1304 is determined based at least in part on a temporally precedent subsegment of the per-channel representation segment for a first image channel representation and a second event data object in an event data object order.

In some embodiments, given m image channel representation and e event data objects, the co-occurrence-based historical representation comprises m cumulative expanded representations, where each cumulative expanded representation is generated based at least in part on all of the expanded event representations for the corresponding image channel representation across all of the e event data objects. In other words, all of the expanded event representations for an ith image channel representation are processed (e.g., by a machine learning model) to generate a cumulative expanded representation for the ith image channel representation, and then the m cumulative expanded representations for the m image channel representations are aggregated to generate the occurrence-based historical representation of the e event data objects.

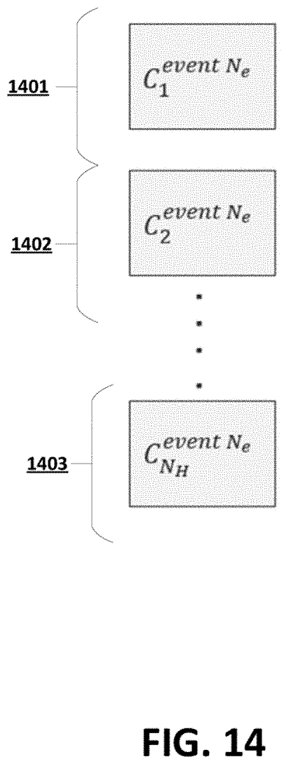

For example, as depicted in FIG. 14, the occurrence-based historical representation 1400 includes three cumulative expanded representations 1401-1403 for three image channel representations, where each cumulative expanded representation is determined based at least in part on the expanded event representations of a set of event data objects for the corresponding image channel representation.

In some embodiments, an occurrence-based historical representation fore event data objects is generated based at least in part on each compact event representation for the e event data objects. For example, in some embodiments, the occurrence-based historical representation is generated based at least in part on a cumulative compact representation generated based at least in part on the output of processing (e.g., using a machine learning model) the e compact event data objects for the e event data objects. As another example, the occurrence-based historical representation comprises e compact cumulative event representations for each of the e event data objects, where the compact cumulative event representation for a particular event data object is determined based at least in part on the output of processing (e.g., using a machine learning model) each compact event representation for any event data object of the e event data objects that occurs prior to the particular event data object. As yet another example, the occurrence-based historical representation comprises e compact cumulative event representations for each of the e event data objects, where the compact cumulative event representation for a particular event data object is determined based at least in part on the output of processing (e.g., using a machine learning model) each compact event representation for any event data object of the e event data objects that occurs prior to the particular event data object as well as the compact event representation for the particular event data object.

Returning to FIG. 4, at step/operation 402, the predictive data analysis computing entity 106 identifies a temporal representation of the sequence of prediction input codes. In some embodiments, the temporal representation describes temporal sequential relationship between occurrences of the sequence of prediction input codes. For example, in some embodiments, the temporal representation of a sequence of prediction input codes each having a timestamp is generated by: (i) for each prediction input code, processing (e.g., using a machine learning model) the prediction input code and a temporal encoding representation of the timestamp to generate a temporal code representation for the prediction input codes, and (ii) aggregating the temporal code representations for the sequence of prediction input codes to generate the temporal representation of the sequence of prediction input codes. In some embodiments, a sequence of prediction input codes is processed by a timeseries processing machine learning model to generate the temporal representation of the sequence of prediction input codes.

At step/operation 403, the predictive data analysis computing entity 106 processes the co-occurrence-based historical representation using a co-occurrence-based prediction machine learning model to generate a co-occurrence-based prediction for the predictive entity. In some embodiments, the co-occurrence-based prediction machine learning model is a trained machine learning model that is configured to process a co-occurrence-based historical representation of a sequence of prediction input codes associated with a predictive entity to generate the co-occurrence-based prediction for the predictive entity. For example, the co-occurrence-based prediction machine learning model may comprise one or more fully connected layers that are collectively configured to process a co-occurrence-based historical representation of a sequence of prediction input codes associated with a predictive entity to generate the co-occurrence-based prediction for the predictive entity.

In some embodiments, inputs to the co-occurrence-based prediction machine learning model comprise one or more vectors corresponding to the co-occurrence-based historical representation, while outputs of the co-occurrence-based prediction machine learning model comprise one or more vectors and/or one or more atomic values corresponding to the co-occurrence-based prediction output. For example, in some embodiments, the outputs of the co-occurrence-based prediction machine learning model may include a vector having v values, where each vector value describes a predicted likelihood that the predictive entity is associated with a diagnosis that is associated with the vector value.

At step/operation 404, the predictive data analysis computing entity 106 processes the temporal historical representation using a temporal prediction machine learning model to generate a temporal prediction for the predictive entity. In some embodiments, the temporal prediction machine learning model is a trained machine learning model that is configured to process a temporal historical representation of a sequence of prediction input codes associated with a predictive entity to generate the temporal prediction for the predictive entity. For example, the temporal prediction machine learning model may comprise one or more fully connected layers that are collectively configured to process a temporal historical representation of a sequence of prediction input codes associated with a predictive entity to generate the temporal prediction for the predictive entity.

In some embodiments, inputs to the temporal prediction machine learning model comprise one or more vectors corresponding to the temporal historical representation, while outputs of the temporal prediction machine learning model comprise one or more vectors and/or one or more atomic values corresponding to the temporal prediction output. For example, in some embodiments, the outputs of the temporal prediction machine learning model may include a vector having v values, where each vector value describes a predicted likelihood that the predictive entity is associated with a diagnosis that is associated with the vector value.

At step/operation 405, the predictive data analysis computing entity 106 determines the hybrid prediction score based at least in part on the co-occurrence-based prediction score and the temporal prediction score. In some embodiments, to generate the hybrid prediction score, the co-occurrence-based prediction score and the temporal prediction score are processed by a machine learning model (e.g., a machine learning model including one or more fully connected layers) to generate an output that can then be used to generate the hybrid prediction score. In some embodiments, the hybrid prediction score includes a vector having v values, where each vector value describes a predicted likelihood that the predictive entity is associated with a diagnosis that is associated with the vector value.

Using hybrid prediction scores, various embodiments of the present invention address operational efficiency and operational reliability of predictive data analysis systems that are configured to perform predictive data analysis operations with respect to input data entities that describe temporal relationships across a large number of prediction input codes. For example, various embodiments of the present invention improve accuracy of predictive outputs generated based at least in part on input data entities that describe temporal relationships across a large number of prediction input codes by using hybrid prediction scores that are determined based at least in part on co-occurrence-based prediction scores and temporal prediction scores, where the co-occurrence-based prediction scores are determined based at least in part on co-occurrence-based historical representation of a sequence of prediction input codes and temporal historical representation of the sequence of prediction input codes. Improving accuracy of predictive output in turn: (i) decreases the number of computational operations performed by processing units of predictive data analysis systems, thus increasing the computational efficiency of predictive data analysis systems, (ii) decreases the overall likelihood of system failure given a constant per-recommendation likelihood failure, thus increasing operational reliability of predictive data analysis systems, and (iii) increases the overall number of end-users that the predictive data analysis system can serve given a constant per-user query count, thus increasing the operational throughput of predictive data analysis systems. Accordingly, various embodiments of the present disclosure make important technical contributions to the field of predictive data analysis by improving computational efficiency, operational reliability, and operational throughput of predictive data analysis systems.

At step/operation 406, the predictive data analysis computing entity 106 performs one or more prediction-based actions based at least in part on the hybrid prediction score. For example, each predictive data analysis computing entity 106 may determine a predictive output based at least in part on the hybrid prediction score for a patient identifier with respect to each medication/treatment regimen that describes success ratios for the medication/treatment regimen in a determined decision subset of the patient identifier. The predictive data analysis computing entity 106 may then perform prediction-based actions based at least in part on a medication/treatment regimen having a highest predictive output (i.e., a highest success ratio). Examples of prediction-based actions include automatic prescription filling operations and/or scheduling automatic consultation sessions to discuss the medication/treatment regimen having the highest predictive output. Other examples of prediction-based actions include automatically transmitting notifications to a computing device of the patient identifier to recommend the medication/treatment regimen having the highest predictive output.

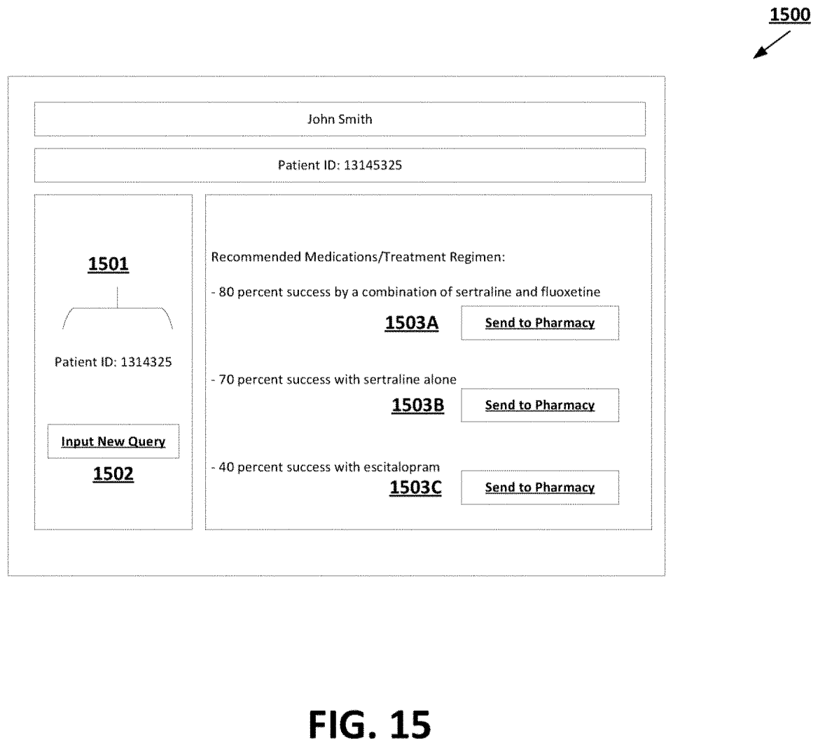

In some embodiments, performing the prediction-based actions includes generating user interface data for a prediction output user interface that describes predictive outputs (e.g., recommendation scores) for a set of candidate medication/treatment regimens that are supplied by an end user and enables filling prescriptions for the noted candidate medication/treatment regimens. An operational example of such a prediction output user interface 1500 is depicted in FIG. 15. As depicted in FIG. 15, the prediction output user interface 1500 is generated in response to a query specifying a patient identifier 1501 that may be modified by selecting the button 1502. The prediction output user interface 1500 displays the recommendation score for each recommended medication/treatment regimen, and enables generating requests for filling prescriptions for each candidate medication/treatment regimen by using the buttons 1503A-1003C.

As described above, various embodiments of the present invention address operational efficiency and operational reliability of predictive data analysis systems that are configured to perform predictive data analysis operations with respect to input data entities that describe temporal relationships across a large number of prediction input codes. For example, various embodiments of the present invention improve accuracy of predictive outputs generated based at least in part on input data entities that describe temporal relationships across a large number of prediction input codes by using hybrid prediction scores that are determined based at least in part on co-occurrence-based prediction scores and temporal prediction scores, where the co-occurrence-based prediction scores are determined based at least in part on co-occurrence-based historical representation of a sequence of prediction input codes and temporal historical representation of the sequence of prediction input codes. Improving accuracy of predictive output in turn: (i) decreases the number of computational operations performed by processing units of predictive data analysis systems, thus increasing the computational efficiency of predictive data analysis systems, (ii) decreases the overall likelihood of system failure given a constant per-recommendation likelihood failure, thus increasing operational reliability of predictive data analysis systems, and (iii) increases the overall number of end-users that the predictive data analysis system can serve given a constant per-user query count, thus increasing the operational throughput of predictive data analysis systems. Accordingly, various embodiments of the present disclosure make important technical contributions to the field of predictive data analysis by improving computational efficiency, operational reliability, and operational throughput of predictive data analysis systems.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for determining a hybrid prediction score for a predictive entity that is associated with a sequence of prediction input codes, the computer-implemented method comprising:
identifying, using one or more processors, a co-occurrence-based historical representation of the sequence of prediction input codes, wherein: (i) each prediction input code is associated with an event data object of a sequence of event data objects, (ii) the co-occurrence-based historical representation is determined based at least in part on each event representation for the sequence of event data objects, and (iii) each event representation is determined based at least in part on each code representation for a code subset of the sequence of prediction input codes that is associated with the event data object for the event representation;
identifying, using the one or more processors, a temporal representation of the sequence of prediction input codes, wherein: (i) each prediction input code is associated with a timestamp, and (ii) the temporal representation is determined based at least in part on each timestamp;
determining, using the one or more processors and a co-occurrence-based prediction machine learning model, and based at least in part on the co-occurrence-based historical representation, a co-occurrence-based prediction score for the predictive entity;
determining, using the one or more processors and a temporal prediction machine learning model and based at least in part on the temporal representation, a temporal prediction score for the predictive entity;
determining, using the one or more processors and based at least in part on the co-occurrence-based prediction score and the temporal prediction score, the hybrid prediction score; and
performing one or more prediction-based actions based at least in part on the hybrid prediction score.

2. The computer-implemented method of claim 1, wherein generating the code representation for a particular prediction input code comprises:
generating an image representation of the particular prediction input code, wherein: (i) the image representation comprises a plurality of image channel representations each associated with a character pattern position of a plurality of character pattern positions, (ii) each image channel representation comprises a plurality of image channel representation regions, (iii) each image channel representation region for an image channel representation corresponds to a character pattern for the character pattern position that is associated with the image channel representation region, and (iv) generating an image channel representation that is associated with a character pattern position is performed based at least in part on the character pattern that is associated with the character pattern position for the image channel representation; and
generating the code representation based at least in part on the image representation.

3. The computer-implemented method of claim 2, wherein:
the plurality of image channel representations is associated with an image channel order that is determined based at least in part on a character pattern position order of the plurality of character pattern positions, and
generating the image representation comprises:
determining a low-ordered subset of the plurality of image channel representations that comprises all of the plurality of image channel representations except a highest-ordered image channel representation as determined based at least in part on the image channel order; and
for each image channel representation in the low-ordered subset that is selected in accordance with the image channel order starting with an in-subset highest-ordered image channel representation in the low-ordered subset:
identifying a successor image channel representation of the plurality of image channel representations for the image channel representation based at least in part on the image channel order,
updating a channel size dimension data object for the image channel representation based at least in part on a successor channel size dimension data object for the image channel representation, and
updating the image channel representation by resizing image channel representation for the image channel representation based at least in part on the channel size dimension data object.

4. The computer-implemented method of claim 3, wherein generating the image representation further comprises:
determining a high-ordered subset of the plurality of image channel representations that comprises all of the plurality of image channel representations except a lowest-ordered image channel representation of the plurality of image channel representations as determined based at least in part on the image channel order; and
for each image channel representation in the high-ordered subset starting with an in-subset lowest-ordered image channel representation in the high-ordered subset:
generating an image location for the image channel representation in the lowest-ordered image channel representation based at least in part on each predecessor image channel representation for the image channel representation as determined based at least in part on the image channel order, and
updating the image channel representation by integrating the image channel representation into the lowest-ordered image channel representation in accordance with the image location.

5. The computer-implemented method of claim 2, wherein:
each event data object is associated with a plurality of co-ordered channel sets for the plurality of image channel representations,
each co-ordered channel set of a particular event data object comprises all image channel representations of the sequence of prediction input codes that are associated with the image channel representation for the co-ordered channel set and the particular event data object, and
generating the event representation for the particular event data object comprises:
for each image channel representation, determining, based at least in part on the co-ordered channel set for the particular event data object and the image channel representation, and using a channel aggregation machine learning model for the image channel representation, an expanded event representation of a plurality of expanded representations for the particular event data object, and
determining the event representation for the particular event data object based at least in part on the plurality of expanded representations for the particular event data object.

6. The computer-implemented method of claim 5, wherein generating the co-occurrence-based historical representation comprises:
for each image channel representation, generating a per-channel representation segment based at least in part on each expanded event representation that is associated with the image channel representation across the sequence of event data objects; and
generating the co-occurrence-based historical representation based at least in part on the per-channel representation segment.

7. The computer-implemented method of claim 6, wherein generating the co-occurrence-based historical representation comprises:
for each image channel representation, generating a cumulative per-channel representation segment that comprises each cumulative expanded event representation that is associated with the image channel representation across the sequence of event data objects, wherein the cumulative expanded event representation for a given event data object and the a given image channel representation is determined based at least in part on a temporally precedent subsegment of the per-channel representation segment for the given event data object and the given image channel representation; and
generating the co-occurrence-based historical representation based at least in part on each cumulative per-channel representation segment.

8. The computer-implemented method of claim 5, wherein determining the event representation for the particular event data object comprises:
generating a compact event representation based at least in part on an output of processing the plurality of expanded representations for the particular event data object using a feature aggregation machine learning model; and
determining the event representation based at least in part on the compact event representation.

9. An apparatus for determining a hybrid prediction score for a predictive entity that is associated with a sequence of prediction input codes, the apparatus comprising at least one processor and at least one memory including program code, the at least one memory and the program code configured to, with the at least one processor, cause the apparatus to at least:
identify a co-occurrence-based historical representation of the sequence of prediction input codes, wherein: (i) each prediction input code is associated with an event data object of a sequence of event data objects, (ii) the co-occurrence-based historical representation is determined based at least in part on each event representation for the sequence of event data objects, and (iii) each event representation is determined based at least in part on each code representation for a code subset of the sequence of prediction input codes that is associated with the event data object for the event representation;
identify a temporal representation of the sequence of prediction input codes, wherein: (i) each prediction input code is associated with a timestamp, and (ii) the temporal representation is determined based at least in part on each timestamp;
determine, using a co-occurrence-based prediction machine learning model and based at least in part on the co-occurrence-based historical representation, a co-occurrence-based prediction score for the predictive entity;
determine, using a temporal prediction machine learning model and based at least in part on the temporal representation, a temporal prediction score for the predictive entity;
determine, based at least in part on the co-occurrence-based prediction score and the temporal prediction score, the hybrid prediction score; and
perform one or more prediction-based actions based at least in part on the hybrid prediction score.

10. The apparatus of claim 9, wherein generating the code representation for a particular prediction input code comprises:
generating an image representation of the particular prediction input code, wherein: (i) the image representation comprises a plurality of image channel representations each associated with a character pattern position of a plurality of character pattern positions, (ii) each image channel representation comprises a plurality of image channel representation regions, (iii) each image channel representation region for an image channel representation corresponds to a character pattern for the character pattern position that is associated with the image channel representation region, and (iv) generating an image channel representation that is associated with a character pattern position is performed based at least in part on the character pattern that is associated with the character pattern position for the image channel representation; and
generating the code representation based at least in part on the image representation.

11. The apparatus of claim 10, wherein:
the plurality of image channel representations is associated with an image channel order that is determined based at least in part on a character pattern position order of the plurality of character pattern positions, and
generating the image representation comprises:
determining a low-ordered subset of the plurality of image channel representations that comprises all of the plurality of image channel representations except a highest-ordered image channel representation as determined based at least in part on the image channel order; and
for each image channel representation in the low-ordered subset that is selected in accordance with the image channel order starting with an in-subset highest-ordered image channel representation in the low-ordered subset:
identifying a successor image channel representation of the plurality of image channel representations for the image channel representation based at least in part on the image channel order,
updating a channel size dimension data object for the image channel representation based at least in part on a successor channel size dimension data object for the image channel representation, and
updating the image channel representation by resizing image channel representation for the image channel representation based at least in part on the channel size dimension data object.

12. The apparatus of claim 11, wherein generating the image representation further comprises:
determining a high-ordered subset of the plurality of image channel representations that comprises all of the plurality of image channel representations except a lowest-ordered image channel representation of the plurality of image channel representations as determined based at least in part on the image channel order; and
for each image channel representation in the high-ordered subset starting with an in-subset lowest-ordered image channel representation in the high-ordered subset:
generating an image location for the image channel representation in the lowest-ordered image channel representation based at least in part on each predecessor image channel representation for the image channel representation as determined based at least in part on the image channel order, and
updating the image channel representation by integrating the image channel representation into the lowest-ordered image channel representation in accordance with the image location.

13. The apparatus of claim 10, wherein:
each event data object is associated with a plurality of co-ordered channel sets for the plurality of image channel representations,
each co-ordered channel set of a particular event data object comprises all image channel representations of the sequence of prediction input codes that are associated with the image channel representation for the co-ordered channel set and the particular event data object, and
generating the event representation for the particular event data object comprises:
for each image channel representation, determining, based at least in part on the co-ordered channel set for the particular event data object and the image channel representation, and using a channel aggregation machine learning model for the image channel representation, an expanded event representation of a plurality of expanded representations for the particular event data object, and
determining the event representation for the particular event data object based at least in part on the plurality of expanded representations for the particular event data object.

14. The apparatus of claim 13, wherein generating the co-occurrence-based historical representation comprises:
for each image channel representation, generating a per-channel representation segment based at least in part on each expanded event representation that is associated with the image channel representation across the sequence of event data objects; and
generating the co-occurrence-based historical representation based at least in part on the per-channel representation segment.

15. The apparatus of claim 14, wherein generating the co-occurrence-based historical representation comprises:
for each image channel representation, generating a cumulative per-channel representation segment that comprises each cumulative expanded event representation that is associated with the image channel representation across the sequence of event data objects, wherein the cumulative expanded event representation for a given event data object and the a given image channel representation is determined based at least in part on a temporally precedent subsegment of the per-channel representation segment for the given event data object and the given image channel representation; and
generating the co-occurrence-based historical representation based at least in part on each cumulative per-channel representation segment.

16. The apparatus of claim 13, wherein determining the event representation for the particular event data object comprises:
generating a compact event representation based at least in part on an output of processing the plurality of expanded representations for the particular event data object using a feature aggregation machine learning model; and
determining the event representation based at least in part on the compact event representation.

17. A computer program product for determining a hybrid prediction score for a predictive entity that is associated with a sequence of prediction input codes, the computer program product comprising at least one non-transitory computer-readable storage medium having computer-readable program code portions stored therein, the computer-readable program code portions configured to:
identify a co-occurrence-based historical representation of the sequence of prediction input codes, wherein: (i) each prediction input code is associated with an event data object of a sequence of event data objects, (ii) the co-occurrence-based historical representation is determined based at least in part on each event representation for the sequence of event data objects, and (iii) each event representation is determined based at least in part on each code representation for a code subset of the sequence of prediction input codes that is associated with the event data object for the event representation;
identify a temporal representation of the sequence of prediction input codes, wherein: (i) each prediction input code is associated with a timestamp, and (ii) the temporal representation is determined based at least in part on each timestamp;
determine, using a co-occurrence-based prediction machine learning model and based at least in part on the co-occurrence-based historical representation, a co-occurrence-based prediction score for the predictive entity;
determine, using a temporal prediction machine learning model and based at least in part on the temporal representation, a temporal prediction score for the predictive entity;
determine, based at least in part on the co-occurrence-based prediction score and the temporal prediction score, the hybrid prediction score; and
perform one or more prediction-based actions based at least in part on the hybrid prediction score.

18. The computer program product of claim 17, wherein generating the code representation for a particular prediction input code comprises:
generating an image representation of the particular prediction input code, wherein: (i) the image representation comprises a plurality of image channel representations each associated with a character pattern position of a plurality of character pattern positions, (ii) each image channel representation comprises a plurality of image channel representation regions, (iii) each image channel representation region for an image channel representation corresponds to a character pattern for the character pattern position that is associated with the image channel representation region, and (iv) generating an image channel representation that is associated with a character pattern position is determined based at least in part on the character pattern that is associated with the character pattern position for the image channel representation; and
generating the code representation based at least in part on the image representation.

19. The computer program product of claim 18, wherein:
the plurality of image channel representations is associated with an image channel order that is determined based at least in part on a character pattern position order of the plurality of character pattern positions, and
generating the image representation comprises:
determining a low-ordered subset of the plurality of image channel representations that comprises all of the plurality of image channel representations except a highest-ordered image channel representation as determined based at least in part on the image channel order; and
for each image channel representation in the low-ordered subset that is selected in accordance with the image channel order starting with an in-subset highest-ordered image channel representation in the low-ordered subset:
identifying a successor image channel representation of the plurality of image channel representations for the image channel representation based at least in part on the image channel order,
updating a channel size dimension data object for the image channel representation based at least in part on a successor channel size dimension data object for the image channel representation, and
updating the image channel representation by resizing image channel representation for the image channel representation based at least in part on the channel size dimension data object.

20. The computer program product of claim 19, wherein generating the image representation further comprises:
determining a high-ordered subset of the plurality of image channel representations that comprises all of the plurality of image channel representations except a lowest-ordered image channel representation of the plurality of image channel representations as determined based at least in part on the image channel order; and
for each image channel representation in the high-ordered subset starting with an in-subset lowest-ordered image channel representation in the high-ordered subset:
generating an image location for the image channel representation in the lowest-ordered image channel representation based at least in part on each predecessor image channel representation for the image channel representation as determined based at least in part on the image channel order, and
updating the image channel representation by integrating the image channel representation into the lowest-ordered image channel representation in accordance with the image location.
